(19) United States
(12) Patent Application Publication
(10) Pub. No.: US 2020/0278680 A1
(43) Pub. Date: Sep. 3, 2020

(54) Method and Device for Operating a Mobile System

(71) Applicant: Robert Bosch GmbH, Stuttgart (DE)

(72) Inventors: Udo Schulz, Vaihingen/Enz (DE); Peter Hertkorn, Ludwigsburg-Neckarweihingen (DE)

(21) Appl. No.: 16/764,556

(22) PCT Filed: Nov. 16, 2018
(86) PCT No.: PCT/EP2018/081622

§ 371 Date: May 15, 2020

(30) Foreign Application Priority Data
Nov. 27, 2017 (DE) 10 2017 221 134.2

(51) Int. Cl. G05D 1/02; B62D 15/02; G05D 1/00; A01B 79/00; A01B 63/00; A01B 69/04

(52) U.S. Cl. CPC G05D 1/0212; G05D 1/0257; G05D 1/0231; B62D 15/025; G05D 2201/0202; A01B 79/005; A01B 63/002; A01B 69/008; G05D 2201/0201; G05D 1/0094

(57) ABSTRACT

A method for operating a mobile system includes detecting a 3D profile of a driving route ahead of defined length, determining a target trajectory of the mobile system and/or of a tool of the mobile system on the basis of the detected 3D profile, operating the mobile system in a defined manner by taking into account the determined target trajectory along the driving route.

The invention relates to a method for operating a mobile system. The invention also relates to a device for operating a mobile system. The invention also relates to a computer program product.

### PRIOR ART

Camera systems that are integrated in vehicle driving-assistance systems are known. In the case of stereoscopic cameras, two or more images of the same scene are acquired from different camera positions. With knowledge of intrinsic and extrinsic calibration parameters of the camera, it is possible to determine a spatial position from the location of a specific scene point in at least two images.

Cameras of this type can be used to create a very accurate 3D surface-profile map (“disparity map”) of the ground in the field of view of the camera.

In principle, distance-measuring systems such as scanning lidar systems, time-of-flight cameras, etc., for instance, can also be used to create such surface-profile maps.

GPS-based automatic steering systems are being used increasingly in particular in agriculture. These help to make use of the full working width and to minimize overlaps of working regions even when conditions in the surrounding area are difficult and/or drivers are inexperienced.

In order to increase the precision, the inaccuracies caused by propagation-delay disturbances in the troposphere and ionosphere and by satellite orbit and clock errors can be corrected by what are known as RTK (real-time kinematics) correction signals.

Knowing the exact location of the antenna is a precondition for acquiring the GPS data. The antenna is usually situated in the center of a cab roof of the agricultural machine. Differences can exist between the determined and actual position of the agricultural machine above ground (e.g. because of tilting, direction of movement, and changes therein, etc.), which can be measured by accelerometers and gyroscopes, for instance.

The GPS, RTK, acceleration and gyroscopic data is combined and processed in what is known as a steering controller or else in the inertial measurement unit (IMU). Kalman filters are used in this process, for example. Finally, hydraulic final control elements of tools and/or a servo on the steering wheel, etc. are controlled.

### DISCLOSURE OF THE INVENTION

An object of the present invention is to provide an improved method for operating a mobile system.

According to a first aspect, the object is achieved by a method for operating a mobile system, comprising the steps:
detecting a 3D profile of a route ahead of defined length;
determining a setpoint trajectory of the mobile system and/or of a tool of the mobile system on the basis of the detected 3D profile; and
operating the mobile system in a defined manner, taking into account the setpoint trajectory along the route.

It is thereby advantageously possible, knowing an accurate three-dimensional surface profile of the route ahead of the mobile system or of a vehicle, to perform a defined action with the vehicle. In particular, knowing the highly accurate three-dimensional surface profile, it is possible to determine a predicted trajectory of the vehicle, which then performs control of at least one actuator of the mobile system or of the vehicle, taking into account mechanics, kinematics, hydraulics, etc. The mobile system is thereby advantageously facilitated to work in a manner that is independent of uneven areas and undulations of the ground.

According to a second aspect, the object is achieved by a device for operating a mobile system, comprising:
a sensor apparatus for detecting in three dimensions a surrounding area of the mobile system; and
a prediction apparatus, which is designed to predict, on the basis of the surrounding area detected in three dimensions, a setpoint trajectory for the mobile system and/or a tool of the mobile system; and
a control apparatus, which is designed to control the mobile system and/or the tool of the mobile system according to the setpoint trajectory.

The subject matter of dependent claims contains advantageous developments of the method.

According to an advantageous development of the method, the following is carried out:
predicting trajectories of wheels of the mobile system and/or of the tool of the mobile system;
determining a predicted deviation from the predicted setpoint trajectory; and
determining feedforward control values for predictive actuator management.

With knowledge of the highly accurate 3D profile, predictive actuator management is controlled by this means, which management optimally takes into account, or compensates for, uneven areas or inhomogeneities ahead in the driving lane for the mobile system. The actuator management may comprise management for a tool or control of a tool of the mobile system.

According to a further advantageous development of the method, at least one of the following is adjusted for the tool: height, direction, tilt. The tool of the mobile system can thereby be operated in a manner that is optimally suited to the topology of the driving lane ahead.

According to a further advantageous development of the method, for the case that sufficient adherence is not possible by means of the setpoint trajectory for the tool, intervention in steering of the mobile system is also performed. Even better compensation for the uneven areas in the driving lane ahead can hence be achieved for the mobile system.

According to a further advantageous development of the method, at least one of the following is used for detecting the 3D profile: lidar, radar, 3D camera, time-of-flight camera. Sensor apparatuses can hence be used that, by virtue of their detection characteristics, are optimally suited to the surrounding area to be detected.

A further advantageous development of the method is characterized in that movements made by the mobile system itself are removed from a camera image by calculation. Wobble errors can thereby be removed advantageously from the image by calculation, thereby providing a steady image, which is advantageous for the subsequent determination of the predicted movements of actuators.

A further advantageous development of the method is characterized in that the 3D profile is detected in a working region of the tool. Efficient 3D detection of the surrounding area of the mobile system is performed by this means, thereby making efficient use of processing capacity.

A further advantageous development of the method is characterized in that the determination of the setpoint trajectory and determining corresponding actuator data are performed by a single control unit. Latency times can hence be reduced advantageously, whereby the proposed method can be executed as quickly as possible.

The invention, including further features and advantages, is described in detail below with reference to a number of figures. All the features described or depicted therein constitute individually, or in any combination, the subject matter of the invention irrespective of how they are combined in the claims or the dependency references thereof, and regardless of the wording and depiction of said features in the description and the figures respectively.

Disclosed method features are obtained analogously from corresponding disclosed device features, and vice versa. This means in particular that features, technical advantages and statements relating to the method for operating a mobile system are obtained analogously from corresponding statements, features and advantages relating to the device for operating a mobile system, and vice versa.

In the figures,

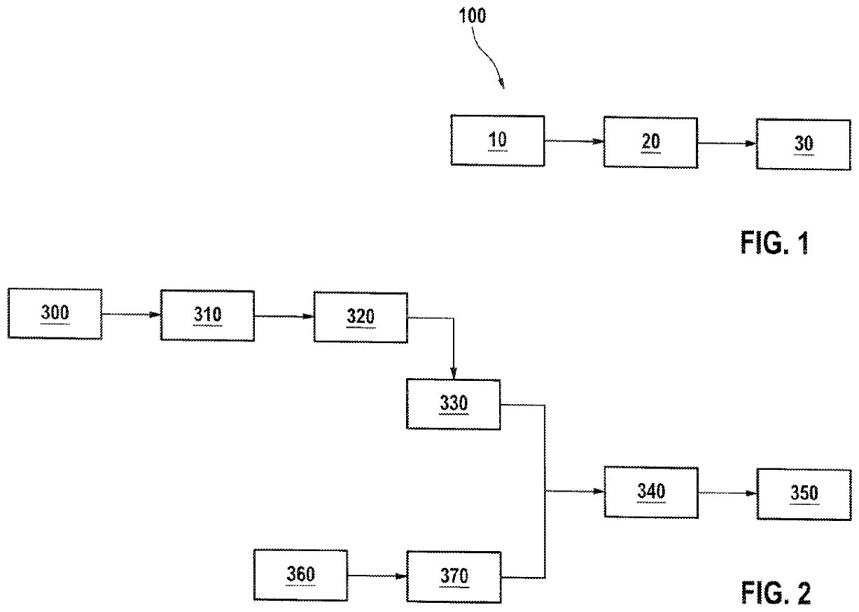

FIG. 1 shows a basic block diagram of an embodiment of a device for operating a mobile system;

FIG. 2 shows a system diagram for explaining a principle of operation of the proposed method;

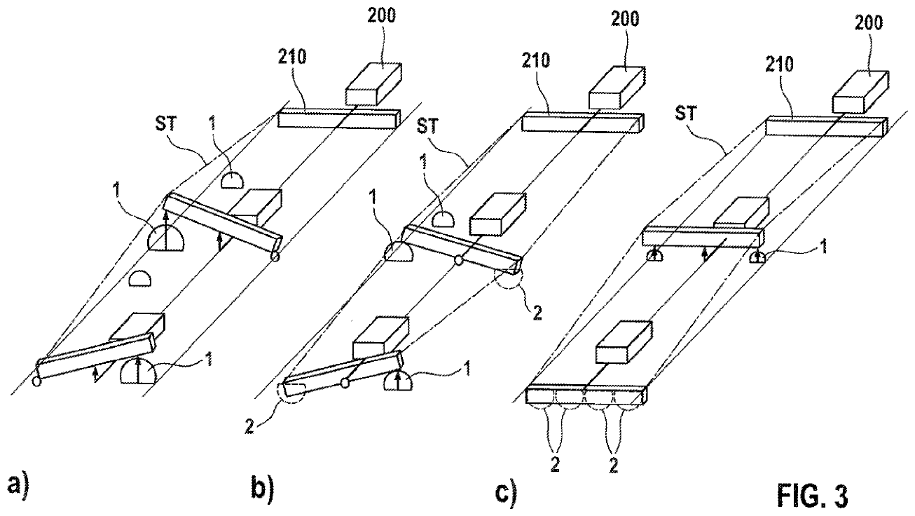

FIG. 3 shows three illustrations for explaining a basic principle of operation of an embodiment of the proposed method;

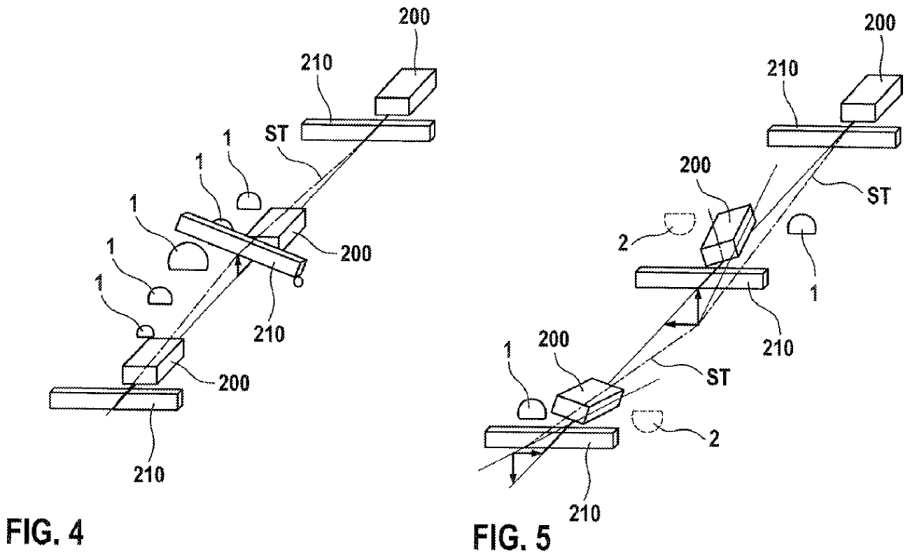

FIG. 4 shows a further diagram for explaining a basic principle of operation of an embodiment of the proposed method;

FIG. 5 shows a further diagram for explaining a basic principle of operation of an embodiment of the proposed method; and

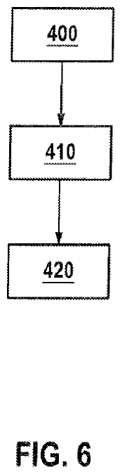

FIG. 6 shows a basic flow diagram of an embodiment of the proposed method.

### DESCRIPTION OF EMBODIMENTS

A core idea of the invention is in particular to provide improved operation of a mobile system. According to this idea, uneven areas of the ground in a driving lane lying in the future or ahead of the mobile system are detected, and prompt/predictive feedforward control of elements (steering and/or tools) of the mobile system is performed on the basis thereof in order to reduce control errors with respect to the GPS position. The greater precision of work processes and lane-keeping achieved thereby advantageously results in greater revenue, reduced compaction of the soil surface and greater acceptance of GPS-based assistance systems for the mobile system.

FIG. 1 shows a schematic block diagram of a device 100 for operating a mobile system 200, for instance in the form of an agricultural machine, a construction vehicle, etc. Said mobile system 200 can be both controlled manually and have an automated or semi-automated, autonomous or semi-autonomous design. The mobile system can both comprise a tool employed during driving to cultivate a land surface and be designed to have no tool.

The figure shows a sensor apparatus 10 for detecting a 3D surrounding-area profile in front of the mobile system 200, which apparatus is functionally connected to a prediction apparatus 20 for determining a predicted trajectory for the mobile system 200. The prediction apparatus 20 determines the predictive trajectory (“setpoint trajectory”) on the basis of data from the detected 3D surrounding-area profile. The prediction apparatus 20 is functionally connected to a control apparatus 30, which is used to control at least one actuator of the mobile system 200 according to the detected three-dimensional profile.

This means, for instance, that actuators are controlled so as to guide the mobile system 200 to achieve optimum lane-keeping. This can also be understood to mean that a tool of the mobile system 200, for instance a mowing implement, construction tool, etc., which is functionally connected to the mobile system 200, is controlled predictively in a feedforward manner with knowledge of the three-dimensional surface profile, and thereby can operate more evenly and hence more efficiently.

Depending on the application, for instance GPS-accurate steering, GPS-accurate working, etc., the process model of the system from GPS reception to the final control element (e.g. wheel, tool) can already be available to the mobile system 200 in advance or be applied at run time of the mobile system 200.

As mentioned above, a 3D surface-profile map can be created by means of distance-measuring techniques including correcting for the movement made by the mobile system 200 itself. The sensors required for this purpose are accordingly fitted in the front region of the mobile system 200. For land surfaces containing plant growth, the exposed surface (usually furrows or fixed driving lanes) are recognized, for example, by feature extraction techniques and, optionally, object classification techniques, and, as such, identified as a surface over which, in principle, it is possible to drive.

The trajectory can be predicted for each wheel or each tool of the mobile system 200 from the specified GPS lane or movement made by the mobile system 200 itself and the 3D surface-profile map.

In particular, tillage, fairways, overgrown areas, soil settlement, natural uneven areas, etc. can produce abrupt height changes in the wheel lanes or tool lanes and hence cause unwanted roll and/or pitch and/or yaw moments.

Mobile systems 200 in the form of agricultural machines usually, as regards the processes to be performed, travel whenever possible in the same lanes in order to minimize the soil area that is compacted and to avoid damaging any plants at all if possible. In this case, the 3D surface-profile map is not substantially changed by the intrinsic weight of the vehicle/of the machine. When traversing for the first time (e.g. as a result of previously ploughed/loosened soil, non-existent travel lanes or furrows), the subsequent soil compaction can be learnt on the first route segment or is applied in advance. This soil compaction can be taken into account, for instance, in the 3D surface-profile map.

It is also conceivable to store and make available to other vehicles/machines, optionally via Cloud/backend devices, the 3D surface-profile map determined by the sensor apparatus 10.

Together with the process model of the system, it is thereby possible to determine predictively the roll, pitch and yaw moments and, depending on the distance in time and/or space from predictive disturbances (roll, pitch and yaw moments), to control accordingly in a feedforward manner the control-loop controllers for steering the mobile system 200 and/or guiding the tools of the mobile system 200. In particular for heavy and hence slow-acting vehicles or machines, this advantageously results in smaller minimum and maximum deviations from the required trajectory of the vehicles and/or tools of the vehicles.

Any control errors that still remain in the controlled process as a result of tolerances, drift, etc. can be learnt and incorporated in the feedforward control.

The predicted and/or real data can optionally be stored in maps and be used for the next traverse by the same or other vehicles and machines, for example in the predictive controllers thereof.

In order to optimize the accuracy of the closed-loop control and real-time capability of the proposed system, an integration approach using a single electronic control unit (e.g. microcontroller, microprocessor and ASIC/DSP) is preferred, because this single control-unit approach has advantages over approaches using a plurality of control units in terms of jitter and latencies in the overall closed-loop control.

Algorithms, sensor-data fusions and also image processing algorithms and 3D maps in particular require the software to be executed in high-performance, large-scale integration microcontrollers, microprocessors and ASICs/DSPs.

FIG. 2 shows a system overview of the proposed method.

In a step 300, a sensor apparatus 10 is provided in the form of surround sensors for detecting in three dimensions the surface profile in front of the mobile system 200, for example one or more 3D cameras, time-of-flight cameras, etc., which, in a step 310, are used to create a high-resolution 3D surface profile. In this process, a detection range of the sensor apparatus 10 corresponds substantially to a working region of the tool 210 of the mobile system 200. In a subsequent step 320, the setpoint trajectory of vehicle wheels and/or tools of the mobile system 200 is predicted. In a step 330, a predicted deviation from the predicted setpoint trajectory is determined.

In a step 340, feedforward control values for predictive actuator management of the mobile system 200 are determined. In a step 350, a predictive manipulated-variable component for the relevant actuator is determined.

In a step 360, kinematics and/or dynamics of the mobile system and/or the tool thereof are taken into account. In addition, in a step 370, a control-system transfer characteristic for the control loop(s) of the working machine (vehicle and tool) is taken into account.

FIG. 3 shows an illustration of a principle of operation of the proposed method. Each of the three illustrations a) to c) shows a mobile system 200, which is embodied as an agricultural machine having a tool 210 (e.g. a mowing implement) mounted thereon. The mobile system 200 uses suitable sensors to determine a 3D surface-profile map of the driving route ahead, and detects by this means any uneven areas in the form of elevations 1 and depressions 2. A setpoint trajectory ST for the tool 210 is determined on the basis of the determined 3D surface profile, and the tool 210 is adjusted along the setpoint trajectory ST during the course of travel along the driving lane.

At the uneven points in the driving lane, the tool 210 thereby finds itself already in the “correct” position as a result of feedforward control carried out, and can thereby operate efficiently. This principle is shown in illustration b) also for depressions 2, and in illustration c) for elevations 1 and depressions 2.

Obviously, this principle can also be used for a mobile system 200 without tools 210. In this case, actuators of the mobile system 200 are used to compensate for the uneven areas 1, 2, so that the mobile system 200 follows a specified driving lane with minimum possible impact from the uneven areas.

FIG. 4 shows a further example of the principle of operation of the proposed method, where in this case the tool 210 follows a course of elevations 1, by which means, for instance, a spraying tool is guided at a defined height above a cereal crop in a field.

FIG. 5 shows a further case, in which the elevations 1 and depressions 2 cause the mobile system 200 to tilt repeatedly along the driving lane. By means of the predicted determination of the setpoint trajectory ST for the tool 210, this tool is nonetheless still able to remain in the intended horizontal working position and hence operate efficiently.

FIG. 6 shows a flow diagram of the proposed method.

In a step 400, a 3D profile of a route ahead of defined length is detected.

In a step 410, a setpoint trajectory ST of the mobile system 200 and/or of a tool 210 of the mobile system 200 is determined on the basis of the detected 3D profile.

In a step 420, a defined operation of the mobile system 200 is performed, taking into account the predicted trajectory ST along the route.

The method according to the invention can be implemented advantageously as software, which runs, for example, on the device 100 comprising the sensor apparatus 10, the prediction apparatus 20 and the control apparatus 30. Easy adaptability of the method can thereby be facilitated.

A person skilled in the art who alters and/or combines the features of the invention in a suitable manner will not depart from the essence of the present invention.

1. A method for operating a mobile system, comprising:
detecting a 3D profile of a route ahead of defined length;
determining a setpoint trajectory of the mobile system and/or of a tool of the mobile system based on the detected 3D profile; and
operating the mobile system in a defined manner, taking into account the determined setpoint trajectory.

2. The method as claimed in claim 1, further comprising:
predicting trajectories of wheels of the mobile system and/or of the tool of the mobile system;
determining a predicted deviation from the predicted setpoint trajectory; and
determining feedforward control values for predictive actuator management.

3. The method as claimed in claim 2, wherein at least one of the following is adjusted for the tool: height, direction, and tilt.

4. The method as claimed in claim 1, wherein when sufficient adherence to the determined setpoint trajectory for the tool is not possible, the method further comprises intervening in steering of the mobile system.

5. The method as claimed in claim 1, wherein at least one of the following is used for detecting the 3D profile: lidar, radar, 3D camera, and time-of-flight camera.

6. The method as claimed claim 1, further comprising:
removing movements made by the mobile system itself from a camera image by calculation.

7. The method as claimed in claim 1, wherein detecting the 3D profile comprises:
detecting the 3D profile in a working region of the tool.

8. The method as claimed in claim 2, wherein the determination of the setpoint trajectory and determining corresponding actuator data are performed by a single control unit.

9. A device for operating a mobile system, comprising:
a sensor apparatus configured to detect in three dimensions a surrounding area of the mobile system; and
a prediction apparatus configured to predict, based on the surrounding area detected in three dimensions, a setpoint trajectory for the mobile system and/or a tool of the mobile system; and
a control apparatus configured to control the mobile system and/or the tool of the mobile system according to the predicted setpoint trajectory.

10. The method as claimed in claim 1, wherein:
a computer program product contains program code for performing the method when the program code is run on an electronic device for operating the mobile system, and
the computer program product is stored on a computer-readable data storage medium.
